(19) United States
(12) Patent Application Publication
(10) Pub. No.: US 2024/0328043 A1
(43) Pub. Date: Oct. 3, 2024

(54) Surface Textile for an Interior Component of a Vehicle, Method for Producing the Surface Textile, Interior Component, and Motor Vehicle

(71) Applicant: Bayerische Motoren Werke Aktiengesellschaft, Muenchen (DE)

(72) Inventors: Thomas AUMANN, Buch am Erlbach (DE); Florian DECHANT, Adlkofen (DE); Johann GASSLHUBER, Buch am Erlbach (DE)

(21) Appl. No.: 18/617,249

(22) Filed: Mar. 26, 2024

(30) Foreign Application Priority Data
Mar. 29, 2023 (DE) 10 2023 107 929.8

(51) Int. Cl. D04B 1/16; B60R 13/02

(52) U.S. Cl. CPC D04B 1/16; B60R 13/02; D10B 2401/041; D10B 2505/12

(57) ABSTRACT

A surface textile for an interior component of a motor vehicle has a front side and a rear side. The rear side is able to be coupled to a carrier for forming the interior component of the motor vehicle. The rear side has at least a slip-resisting property. The front side and the rear side differ from one another in terms of their textile structure and/or in terms of their textile composition.

### CROSS REFERENCE TO RELATED APPLICATION

This application claims priority under 35 U.S.C. § 119 from German Patent Application No. 10 2023 107 929.8, filed Mar. 29, 2023, the entire disclosure of which is herein expressly incorporated by reference.

### BACKGROUND AND SUMMARY

The present invention relates to a surface textile for an interior component of a motor vehicle.

The invention furthermore relates to a method for producing a surface textile of said type, to an interior component having a surface textile of said type, and to a motor vehicle having an interior component of said type and/or having a surface textile of said type.

In vehicle construction, components, and in particular interior components, are increasingly being laminated with textiles as surface material. For this purpose, the surface material is adhesively bonded by adhesive or laminating adhesive to the carrier surfaces of the interior components.

A multiplicity of interior components which are laminated with a textile exist in vehicles. Textiles are more difficult to maintain than, for example, plastic. Therefore, interior components with textile as surface material generally have a shorter life cycle than the vehicle itself. Specifically in used vehicles, interior components with such an adhesively bonded surface material are disadvantageous since it is difficult for the surface material to be changed owing to the adhesive used.

At the end of the life cycle of the vehicle, it is generally desired for the parts of the vehicle to be sorted according to materials, so as to allow recycling or reuse. The fact that the surface material is laminated onto the carrier surfaces of the interior components by adhesive means that reuse of the different materials of the interior components is possible only to a limited extent.

It is therefore an object of the present invention to at least partially eliminate the above-described disadvantages in the case of a surface textile. In particular, it is an object of the present invention to provide a surface textile, an interior component and a method for producing the surface textile that make it possible to refrain from using adhesive or laminating adhesive, in particular when coupling the carrier of the interior component to the surface textile, in a simple and inexpensive manner. In particular, it is an object of the present invention to provide a surface textile, an interior component and a method for producing the surface textile that make it possible for the same to be reusable.

To achieve the object, a surface textile having the features of claim 1, a method having the features of claim 7, an interior component having the features of claim 8 and a motor vehicle having the features of claim 12 are proposed.

Advantageous configurations of the apparatus are the subject matter of the dependent claims.

According to a first aspect of the invention, a surface textile for an interior component of a motor vehicle is proposed. The surface textile has a front side and a rear side. The rear side is able to be coupled to a carrier for forming the interior component of the motor vehicle. The rear side has in this case at least a slip-resisting property. The front side and the rear side differ from one another in terms of their textile structure and/or in terms of their textile composition.

Since the rear side of the surface textile has a slip-resisting property, it is possible for such a surface structure to be coupled to a carrier of the interior component in such a way that use of adhesive is not intended and yet the surface textile cannot be displaced, or can be displaced only to a negligible extent, relative to the carrier.

In the case of use of adhesive being refrained from during the coupling of the surface textile to the carrier of the interior component, in the case of known surface textiles, displaceability of the surface textile relative to the carrier can occur. The surface textile according to the invention, which has a slip-resisting rear side, makes it possible for such displaceability to be avoided or at least greatly reduced.

In order, nevertheless, not to adversely affect the appearance of the overall interior component and to continue to be able to provide a desired appearance of the surface textile, it is advantageous that the front side and the rear side differ from one another in terms of their textile structure and/or in terms of their textile composition. In this way, despite a rear side having a slip-resisting property, a front side of the surface textile which satisfies certain visual requirements can be provided.

Such a surface textile furthermore allows the haptic properties of the surface textile, in particular on a carrier of the interior component, to be improved.

The term motor vehicle should be understood broadly in the present case. Accordingly, a motor vehicle may be an automobile, an aircraft or a train.

The surface textile may be a cover. The surface textile may consist of one or more textiles. The surface textile may comprise natural fibers and/or man-made fibers. The surface textile may comprise a textile sheet-like structure, such as for example woven fabrics, warp-knitted fabrics, weft-knitted fabrics, braided fabrics, stitch-bonded fabrics, nonwoven fabrics and/or felts.

It should be noted that the surface textile may additionally comprise non-textile raw materials, such as for example leathers, spring materials and/or flaked materials. Alternatively, the surface textile may be free of non-textile raw materials.

The slip-resisting property may be an adhesive property or frictional property. The slip-resisting property is intended in principle to make possible better adhesion of the surface material to the carrier of the internal component. The slip-resisting property allows the frictional force of the surface material on the carrier of the interior component to be increased. The slip-resisting property of the rear side allows the adhesion of the surface textile to the carrier of the interior component to be increased despite an adhesive being dispensed with.

The interior component may be any element, in particular any visible component, of interior equipment of a motor vehicle. Trim parts and/or installation parts of the interior compartment of the motor vehicle may constitute the interior component. Examples include instrument panel, rear seat installation, central console, ceiling of the motor vehicle and/or carpets. Alternatively, or additionally, the interior component may be a piece of furniture, for example of a motorhome or the like.

In summary, provision may be made of a surface textile which can be exchangeably coupled to the carrier for forming the interior component and, at the same time, remains areally positioned on the carrier and cannot be displaced.

In an advantageous configuration, the surface textile is a weft-knitted fabric composed of at least one yarn.

In an advantageous configuration, the rear side has different yarns than the front side.

In an advantageous configuration, the rear side comprises a textile material, in particular spandex and/or viscose, which has a slip-resisting property. In other words, the slip-resisting property of the rear side of the surface textile can be achieved in that, for example during the production process of the surface material, in particular of the weft-knitted fabric, an additional yarn having the corresponding properties is introduced.

In an advantageous configuration, the rear side has a rough and/or lamellar surface structure. In this way, a better slip-resisting property of the rear side can be provided. With a lamellar surface structure, it is possible for the gecko effect to be achieved. A rough surface structure makes it possible for example for a lotus effect, in particular of the lotus leaf, to also be achieved.

In an advantageous configuration, the rear side has a 3D surface structure. In this way, the adhesiveness of the rear side of the surface textile can be further increased.

According to a second aspect of the invention, a method for producing a surface textile, as described above and below, is proposed. In the method, firstly a textile, in particular a weft-knitted material, having a front side and a rear side is produced. Moreover, the front side and the rear side are produced differently in terms of their textile structure and/or in terms of their textile composition. The rear side has in this case at least a slip-resisting property.

For this purpose, it may be provided that the slip-resisting property of the rear side is achieved through reworking of the rear side. Following the production of the textile, the rear side can accordingly be correspondingly re-designed or reworked.

All the advantages that have already been described with regard to a surface textile according to the first aspect of the invention arise in the case of the method described.

According to a third aspect of the invention, an interior component for a motor vehicle is proposed. The interior component has a carrier and a surface textile, as described above and below, and/or a surface textile produced by way of a method, as described above.

All the advantages that have already been described with regard to a surface textile according to the first aspect of the invention arise in the case of the interior component described.

In an advantageous configuration of the interior component, the surface textile is separably, in particular exchangeably, coupled to the carrier. In other words, the surface textile may be coupled at the carrier in such a way that, if the surface textile is removed from the carrier, the surface textile sustains little to no damage, in particular damage merely at the edge points. In the present case, the expression “to be coupled” can be understood as meaning that the surface textile is attached to the carrier in a slip-resistant manner and so as to be positioned fixedly in an areal manner. A coupling of the two elements may presuppose a fastening, but may alternatively refer to a fastening-free coupling or attachment to one another.

In an advantageous configuration of the interior component, the carrier has a rough and/or 3D surface structure. In this way, the slip-resisting property of the rear side of the surface textile can be better utilized. In this way, the adhesion of the surface textile to the carrier can be further increased, so that a displaceability of the surface textile relative to the carrier can be further reduced.

In an advantageous configuration of the interior component, a slip-resisting intermediate layer is furthermore arranged between the carrier and the surface textile. The intermediate layer may be referred to as a coating of the carrier or alternatively as a coating of the rear side of the surface textile.

According to a fourth aspect of the invention, a motor vehicle having an interior component, as described above and below, and/or having a surface textile, as described above and below, is proposed.

All the advantages that have already been described with regard to a surface textile according to the first aspect of the invention and/or with regard to the interior component according to the third aspect of the invention arise in the case of the motor vehicle described.

A surface textile, an interior component, a method for producing a surface textile and further features and advantages will be discussed in more detail below on the basis of exemplary embodiments, which are illustrated schematically in the figures. In the figures, in each case schematically:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a surface textile according to an exemplary embodiment;

FIG. 2 shows an interior component according to an exemplary embodiment; and

FIG. 3 shows an exploded view of an interior component according to a further exemplary embodiment.

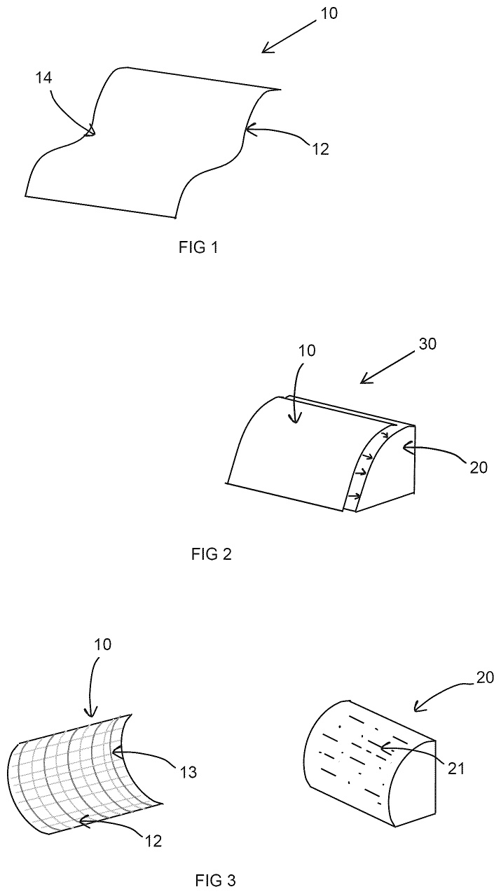

Elements with the same function and effect are in each case denoted by the same reference signs in FIGS. 1 to 3.

### DETAILED DESCRIPTION OF THE DRAWINGS

FIG. 1 schematically shows a surface textile 10 according to an exemplary embodiment. The surface textile 10 has a front side 14 and a rear side 12. The front side 14 and the rear side 12 differ from one another in terms of their textile structure and/or in terms of their textile composition. A different textile structure can be achieved through different production steps. A different textile structure does not rule out the possibility of the front side 14 and the rear side 12 having the same textile composition, in particular the same yarn composition. The rear side 12 has a slip-resisting property. The rear side 12 is therefore formed in such a way that the surface textile 10 can adhere to the carrier 20 and/or that, due to the rear side 12, the surface textile 10 exhibits a predefined or desired adhesiveness.

FIG. 2 schematically shows an interior component 30 according to an exemplary embodiment. The interior component 30 may be an element of the interior equipment of the motor vehicle. The interior component 30 may accordingly be for example a door paneling, a vehicle pillar, an instrument panel, for example with internal components, a central console and/or the steering wheel.

FIG. 2 schematically illustrates the attachment of the surface material to the carrier 20 by means of arrows. After the attachment or coupling of the surface textile 10 to the carrier of the interior component 30, the surface material is preferably coupled to the carrier in such a way that the surface material cannot be displaced relative to the carrier 20. The surface material is no longer areally displaceable. This is achieved by the slip-resisting property of the rear side 12 of the surface material. In FIG. 2, the surface material is made to span the carrier 20.

FIG. 3 shows an exploded view of an interior component 30 according to a further exemplary embodiment. The rear side 12 of the surface textile 10 has a surface structure. The surface structure may also be referred to as functional surface. In this case, it may be a gecko-like surface structure 13, that is to say a surface structure with a gecko effect. In the case of the gecko-like surface structure 13, the surface of the rear side 12 may be of lamellar form. Additionally, or alternatively, it is conceivable for the carrier 20 to have a functional surface or a surface structure 21. For this purpose, it is possible for example that the carrier 20 has grains and/or a rough surface.

It should additionally be pointed out that the terms “comprising” and “having” do not rule out any other elements, and the indefinite articles “a”, “an” and “one” do not rule out a multiplicity. It should furthermore be pointed out that features and steps that have been described with reference to one of the above exemplary embodiments can also be used in combination with other features and steps of other exemplary embodiments described above. Reference signs in the claims should not be regarded as being limiting.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

10 Surface textile
12 Rear side
13 Surface structure of the rear side
14 Front side
20 Carrier
21 Surface structure of the carrier
30 Interior component

What is claimed is:

1. A surface textile for an interior component of a motor vehicle, the surface textile comprising:
a front side and a rear side,
wherein the rear side is able to be coupled to a carrier for forming the interior component of the motor vehicle,
wherein the rear side has at least a slip-resisting property, and
wherein the front side and the rear side differ from one another in terms of their textile structure and/or in terms of their textile composition.

2. The surface textile according to claim 1, wherein the surface textile is a weft-knitted fabric composed of at least one yarn.

3. The surface textile according to claim 2, wherein the rear side has different yarns than the front side.

4. The surface textile according to claim 1, wherein the rear side comprises a textile material, in particular spandex and/or viscose, which has a slip-resisting property.

5. The surface textile according to claim 1, wherein the rear side has a rough and/or lamellar surface structure.

6. The surface textile according to claim 1, wherein the rear side has a 3D surface structure.

7. A method for producing a surface textile, comprising:
producing a textile, in particular a weft-knitted fabric, having a front side and a rear side,
wherein the front side and the rear side are produced differently in terms of their textile structure and/or in terms of their textile composition, and
wherein the rear side has at least a slip-resisting property.

8. An interior component for a motor vehicle, having a carrier and a surface textile according to claim 1.

9. The interior component according to claim 8, wherein the surface textile is separably coupled to the carrier.

10. The interior component according to claim 8, wherein the carrier has a rough and/or 3D surface structure.

11. The interior component according to claim 8, wherein a slip-resisting intermediate layer is furthermore arranged between the carrier and the surface textile.

12. A motor vehicle having an interior component according to claim 8.
